(19) United States
(12) Patent Application Publication
(10) Pub. No.: US 2026/0017174 A1
(43) Pub. Date: Jan. 15, 2026

(54) DETECTING BUGS USING LARGE LANGUAGE MODELS

(71) Applicant: International Business Machines Corporation, Armonk, NY (US)

(72) Inventors: Qiushi Wu, Ossining, NY (US); Zhongshu Gu, Ridgewood, NJ (US); Enriquillo Valdez, Queens, NY (US); Hani Talal Jamjoom, Cos Cob, CT (US)

(21) Appl. No.: 18/772,709

(22) Filed: Jul. 15, 2024

(51) Int. Cl. G06F 11/36; G06F 8/41; G06F 21/57

(52) U.S. Cl. CPC G06F 11/3624; G06F 8/433; G06F 21/577

(57) ABSTRACT

A computer-implemented method for detecting bugs in an application. A processor set receives a patch for fixing one or more bugs in the application. The processor set analyzes the patch to identify security rules violated by the one or more bugs using a large language model. The processor set identifies code contexts associated with code segments in the patch. The code segments are responsible for the one or more bugs in the application. The processor set identifies a number of target code segments in the application that are potentially affected by the one or more bugs. The processor set generates a prompt for the large language model for each target code segment in the number of target code segments to detect other bugs in the application. The prompt is generated based on security rules, the code contexts, and the number of target code segments in the application.

### BACKGROUND

The disclosure relates generally to detecting bugs in program instructions and more specifically to detecting bugs in program instructions using large language models.

Bugs in program instructions are errors, flaws, or faults that cause software to produce incorrect or unexpected results or to behave in unintended ways. A small mistake in code can lead to significant issues. In this case, bugs can cause a wide range of issues from incorrect user interface element to crashes or data corruptions that prevent software from functioning. Bugs can arise at any stage of software development lifecycle, which includes during design, coding, testing, and maintenance.

The impact of bugs extends beyond the functionality of program instructions. For example, encountering bugs for a user can lead to bad user experience and decreased productivity. In another example, encountering bugs for an organization can result in financial losses from system downtime and increased support cost. In some cases, bugs can also compromise data integrity and security, and therefore exposing sensitive information to unauthorized access.

### SUMMARY

According to one illustrative embodiment, a computer-implemented method for detecting bugs in an application is provided. A processor set receives a patch for fixing one or more bugs in the application. The processor set analyzes the patch to identify security rules violated by the one or more bugs using a large language model. The processor set identifies code contexts associated with code segments in the patch. The code segments are responsible for the one or more bugs in the application. The processor set identifies a number of target code segments in the application that are potentially affected by the one or more bugs. The processor set generates a prompt for the large language model for each target code segment in the number of target code segments to detect other bugs in the application. The prompt is generated based on security rules, the code contexts and the number of target code segments in the application. According to other illustrative embodiments, a computer system, and a computer program product for optimizing memory usage are provided.

### BRIEF DESCRIPTION OF THE DRAWINGS

FIG. 1 is a pictorial representation of a computing environment in which illustrative embodiments may be implemented;

FIG. 2 is an illustration of a block diagram of a security management environment in accordance with an illustrative embodiment;

FIG. 3 is an illustration of a patch for fixing bugs in accordance with an illustrative embodiment;

FIG. 4 is a graph to illustrate associations between variables and caller functions for identifying context for target code segment that are potentially affected by existing bugs in accordance with an illustrative embodiment;

FIG. 5 is an illustration of a prompt for a large language model to detect bugs in accordance with an illustrative embodiment;

FIG. 6 is a flowchart of a process for detecting bugs in an application in accordance with an illustrative embodiment;

FIG. 7 is a flowchart of a process for inputting prompt to a large language model in accordance with an illustrative embodiment;

FIG. 8 is a flowchart of a process for identifying code contexts in accordance with an illustrative embodiment;

FIG. 9 is a flowchart of a process for identifying target code segments in the application in accordance with an illustrative embodiment;

FIG. 10 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

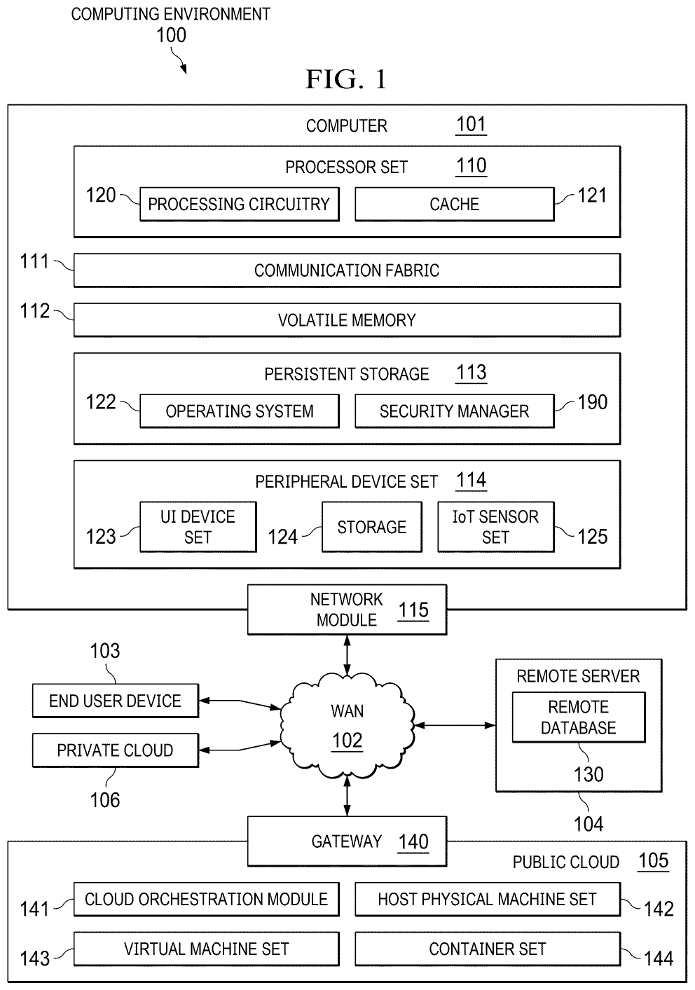

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as security manager 190. In addition to security manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and security manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in security manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in security manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that current methods are unable to autonomously interpret and utilize patches that can be used to update software. In this case, program analysis requires manual efforts to summarize and encode coding rules.

The illustrative embodiments recognize and take into account that a patch may not address all errors caused by a bug in an application. The illustrative embodiments also recognize and take into account that dynamic code analysis can only inspect a limited section of program instructions due to path explosion and hardware limitations. In addition, the illustrative embodiments also recognize and take into account that static code analysis is restricted to detecting a narrow spectrum of bugs due to the fact that static code analysis is largely dependent on human-defined rules or statistical evaluations.

Thus, illustrative embodiments of the present invention provide a computer implemented method, computer system, and computer program product for detecting bugs in an application in an autonomous manner to increase computer performance. A processor set receives a patch for fixing one or more bugs in the application. The processor set analyzes the patch to identify security rules violated by the one or more bugs using a large language model. The processor set identifies code contexts associated with code segments in the patch. The code segments are responsible for the one or more bugs in the application. The processor set identifies a number of target code segments in the application that are potentially affected by the one or more bugs. The processor set generates a prompt for the large language model for each target code segment in the number of target code segments to detect other bugs in the application. The prompt is generated based on security rules, the code contexts and the number of target code segments in the application.

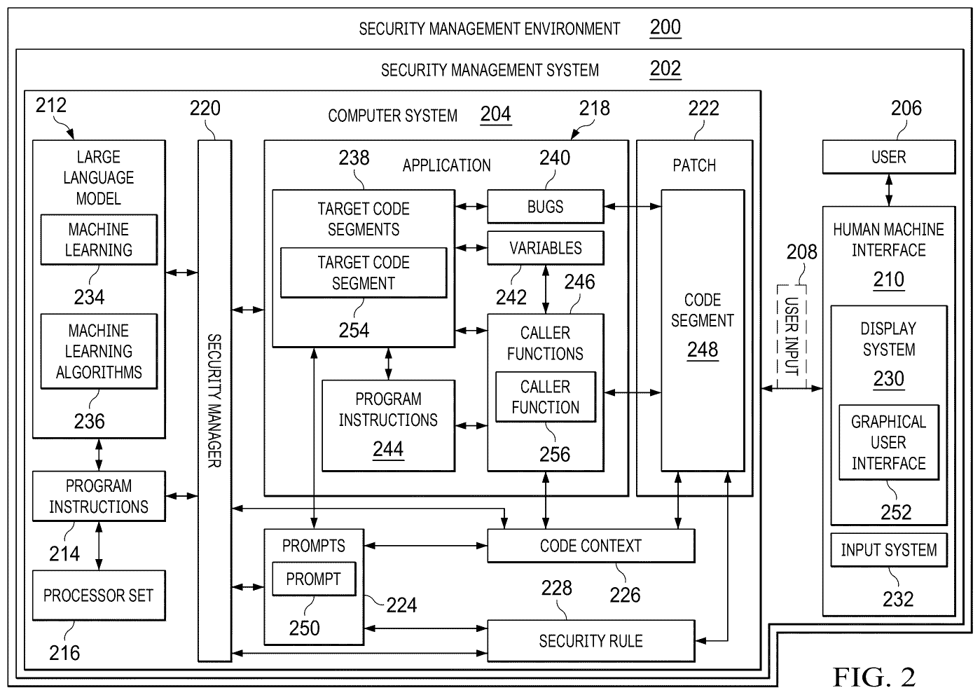

With reference now to FIG. 2, an illustration of a block diagram of a security management environment is depicted in accordance with an illustrative embodiment. In this illustrative example, security management environment 200 includes components that can be implemented in hardware such as the hardware shown in computing environment 100 in FIG. 1.

In this illustrative example, security management system 202 in security management environment 200 detects bugs for application 218 in computer system 204. In this illustrative example, security management system 202 includes computer system 204 which includes security manager 220. Security manager 220 is located in computer system 204. Security manager 220 may be implemented using security manager 190 in FIG. 1.

Security manager 220 can be implemented in software, hardware, firmware, or a combination thereof. When software is used, the operations performed by security manager 220 can be implemented in program instructions configured to run on hardware, such as a processor unit. When firmware is used, the operations performed by security manager 220 can be implemented in program instructions and data and stored in persistent memory to run on a processor unit. When hardware is employed, the hardware can include circuits that operate to perform the operations in security manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes application 218 and patch 222. In this illustrative example, application 218 is a program or a group of programs that include program instructions to perform specific tasks for end-users. Patch 222 is a set of program instructions released by the software developers to fix specific issues and bugs, enhance functionality, or improve security for applications. In this illustrative example, patch 222 includes code segment 248 that is responsible for one or more bugs from bugs 240 in application 218.

In addition, computer system 204 includes large language model 212. In this illustrative example, large language model 212 is an artificial intelligence model that understands human language and can help security manager 220 to detect bugs in application 218. In this illustrative example, large language model 212 can be a general-purpose model that is configured to perform a wide range of tasks or a model that is specifically trained for detecting bugs in applications.

Large language model 212 can include machine learning 234 and machine learning algorithms 236. Machine learning 234 is a branch of artificial intelligence (AI) that enables computers to detect patterns and improve performance without direct programming commands. Rather than relying on direct input commands to complete a task, machine learning 234 relies on input data. The data is fed into the machine, one of machine learning algorithms 236 is selected, parameters for the data are configured, and the machine is instructed to find patterns in the input data through optimization algorithms. The data model formed from analyzing the data is then used to predict future values.

Large language model 212 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching large language model 212. In this illustrative example, large language model 212 can be retrained using outputs from large language model 212 to improve accuracy and efficiency of predictions made by large language model 212.

Large language model 212 can be implemented using one or more systems such as an artificial intelligence system, a neural network, a generative neural network, a Bayesian network, an expert system, a fuzzy logic system, a genetic algorithm, or other suitable types of systems. Machine learning 234 and machine learning algorithms 236 may make computer system 204 a special purpose computer for detecting bugs for applications such as application 218.

Machine learning 234 involves using machine learning algorithms 236 to build large language model 212 based on samples of data. The samples of data used for training are referred to as training data or training datasets. Large language model 212 can make predictions without being explicitly programmed to make these predictions. Large language model 212 can be trained and retrained for a number of different types of applications. These applications include, for example, medicine, financial services, healthcare, speech recognition, computer vision, or other types of applications.

In this illustrative example, machine learning algorithms 236 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

In this illustrative example, security manager 220 can analyze descriptions and code changes from patch 222 using large language model 212 to summarize patch 222 into security rule 228. In this illustrative example, security rule 228 is a guideline, constraint, or protocol embedded within program instructions to ensure that program operates securely. In this illustrative example, security rule 228 is the rule that is violated by bugs 240 caused by code segment 248.

In addition, security manager 220 can also collect git commit for fixing bugs in application 218 and input git commits along with descriptions and code changes from patch 222 to large language model 212 for generating security rule 228. In this illustrative example, git commits are changes in Git repository for managing and tracking changes in files and directories. When git commits are made, changes in program instructions are saved to the Git repository to create a history of project development.

In this illustrative example, security manager 220 can also identify code context 226 for patch 222. Code context 226 is the surrounding information and environment in which program instructions such as code segment 248 in patch 222 are interpreted and operated. In this illustrative example, code context 226 can include scope of program instructions, namespaces, call stacks, external libraries and dependencies, surrounding codes, relationships between code segments, any code with a data or control relationships with program instructions in patch 222, or any suitable information associated with program instructions in patch 222. For example, security manager 220 can extract the caller function for code segment 248 and expand the call function to be part of code context 226.

In this illustrative example, security manager 220 can also identify target code segments 238 in application 218. Target code segments 238 is a portion of program instructions for application 218 that are potentially affected by existing bugs. For example, target code segment 254 can be program instructions that is potentially affected by bugs 240 caused by code segment 248. In this illustrative example, a patch such as patch 222 typically only fixes one uses of code segment 248 in application 218. However, other uses of code segment 248 in application 218 may suffer from similar errors and are addressed by patch 222.

In this illustrative example, security manager 220 can identify caller functions 246 for target code segment 254 by querying the call graph for target code segment 254. In this illustrative example, caller functions 246 are functions that invoke or call target code segment 254. In other words, caller functions 246 include other program instructions in application 218 that are potentially affected by bugs 240 caused by code segment 248. In this illustrative example, each caller function in caller functions 246 is associated with a number of program instructions and variables that are potentially affected by bugs 240 caused by code segment 248.

For example, security manager 220 can identify variables 242 and program instructions 244 associated with caller function 256 for target code segment 254. In other words, variables 242 and program instructions 244 are potentially affected by bugs 240 caused by code segment 248. In this illustrative example, security manager 220 can identify variables 242 and program instructions 244 associated with caller function 256 for target code segment 254 using data flow analysis or control flow analysis.

It should be understood that program instructions 244 and program instructions 214 are different program instructions. In this illustrative example, program instructions 214 are instructions that implement processes in the illustrative examples and program instructions 244 are instructions in application 218 that are potentially affected by bugs 240 caused by code segment 248.

In this illustrative example, security manager 220 generates prompts 224 that can be used as input to large language model 212 for identifying whether any target code segment in target code segments 238 is in fact affected by bugs 240 caused by code segment 248. For example, security manager 220 can generate prompt 250 that includes variables 242, program instructions 244, caller functions 246, code context 226, and security rule 228 as input to large language model 212. Large language model 212 identifies whether target code segment 254 is affected by bugs 240 caused by code segment 248. As a result, large language model detects program instructions that suffer similar error from bugs 240 that are not addressed by patch 222.

In this illustrative example, user 206 can interact with computer system 204 through user inputs to computer system 204. For example, computer system 204 can receive user input 208 that includes other information associated with patch 222 and target code segments 238 to be included in prompts 224 such that large language model 212 can perform tasks more effectively.

In this illustrative example, user input 208 can be generated by user 206 using human machine interface (HMI) 210. As depicted, human machine interface 210 includes display system 230 and input system 232. Display system 230 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 252 through user input 208 generated by input system 232. Input system 232 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device. For example, user 206 can view code context 226, security rule 228, caller functions 246, variables 242, program instructions 244, and prompts 224 using graphical user interface 252 in display system 230.

In one illustrative example, one or more solutions are present that overcome a problem with detecting similar bug in an application that are not addressed by a patch that includes code segment that causes the bug. As a result, one or more technical solutions may provide an ability to increase the efficiency for detecting bugs in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which security manager 220 in computer system 204 enables detecting bugs in application 218. In particular, security manager 220 transforms computer system 204 into a special purpose computer system as compared to currently available general computer systems that do not have a security manager 220.

In the illustrative example, the use of security manager 220 in computer system 204 integrates processes into a practical application for detecting bugs because security manager 220 detects vulnerabilities in computer system 204 such that performance of computer system 204 can be increased. In other words, security manager 220 in computer system 204 is directed to a practical application of processes integrated into security manager 220 in computer system 204 that detects bug in an application that are not addressed by a patch that includes code segment that causes the bug.

The illustration of security management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, patch 222 can include multiple segments that are responsible for multiple bugs in application 218 and multiple prompts in prompts 224 can be generated in parallel for multiple target code segments in target code segments 238. In addition, large language model 212 can include multiple large language models such that security manager 220 can perform different tasks using different large language models.

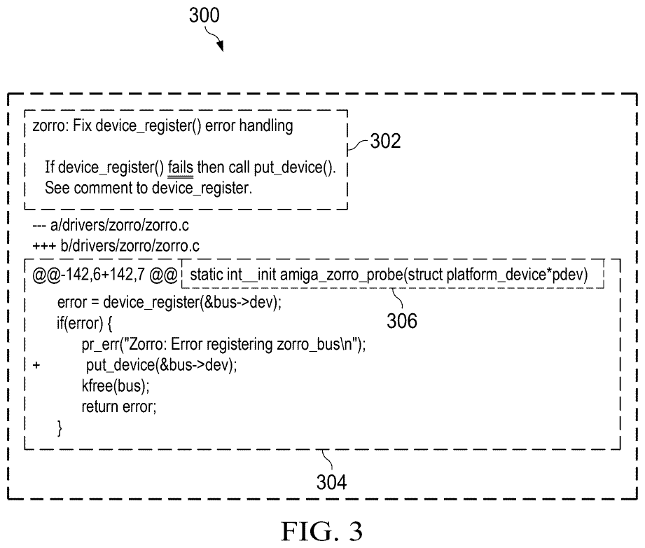

With reference now to FIG. 3, a patch for fixing bugs is shown in accordance with an illustrative embodiment. In FIG. 3, patch 300 can be analyzed to identify security rules and patch details associated with patch 300. In this illustrative example, patch 300 can be an example of patch 222 in FIG. 2.

Patch 300 includes patch description 302 and code changes 304. In this illustrative example, patch description 302 and code changes 304 outline issues that patch 300 addresses and how those issues can be resolved. Patch description 302 and code changes 304 can be analyzed to identify security rule violated by the bugs addressed by patch 300. The security rule violated by the bugs addressed by patch 300 is the rule in program instructions that are violated by the vulnerability resulted from bugs. In this illustrative example, the security rules can be generated by summarizing patch 300.

For example, the security rule can be summarized by inputting patch description 302 and code changes 304, along with git commits for fixing bugs in program instructions into a large language model. In this illustrative example, git commits are changes in Git repository for managing and tracking changes in files and directories. When git commits are made, changes in program instructions are saved to the Git repository to create a history of project development. In this example, the large language model can be a general purpose model that extracts information from patch description 302, code changes 304, and the git commits and summarizes patch 300 into a single security rule. For example, the security rule for patch 300 can be “if device_register( ) fails, put_device( ) should be called to properly manage resources and prevent leak”. In other words, device_register( ) is the code segment that is responsible for the bug addressed by patch 300.

In addition, patch 300 can also provide code context associated with the code segment responsible for the bug addressed by patch 300. As depicted, code context refers to the surrounding information and environment in which a piece of program instruction is interpreted and operated. Code context for the code segment of “device_register( )”. in FIG. 3 can include surrounding code, execution environment, data flow, dependencies, call hierarchy, or any suitable information associated with the code segment of “device_register( )”. For example, caller function 306 for the code segment of “device_register( )” can be extracted and expanded as dependency for the code segment of “device_register( )” to be part of the code text for code segment of “device_register( )”. In this illustrative example, caller function 306 is expanded as “static int init amiga_zorro_probe( . . . ) { . . . }”. In this illustrative example, code context for code segment of “device_register( )” in patch 300 can include patch description 302, code changes 304, and the caller function 306.

The illustration of patch 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, patch 300 can include multiple code segments that are responsible for the bugs and therefore code context can include contextual information for multiple code segments in the patch. In another example, code context for code segments in patch 300 can also serve as contextual information for patch 300.

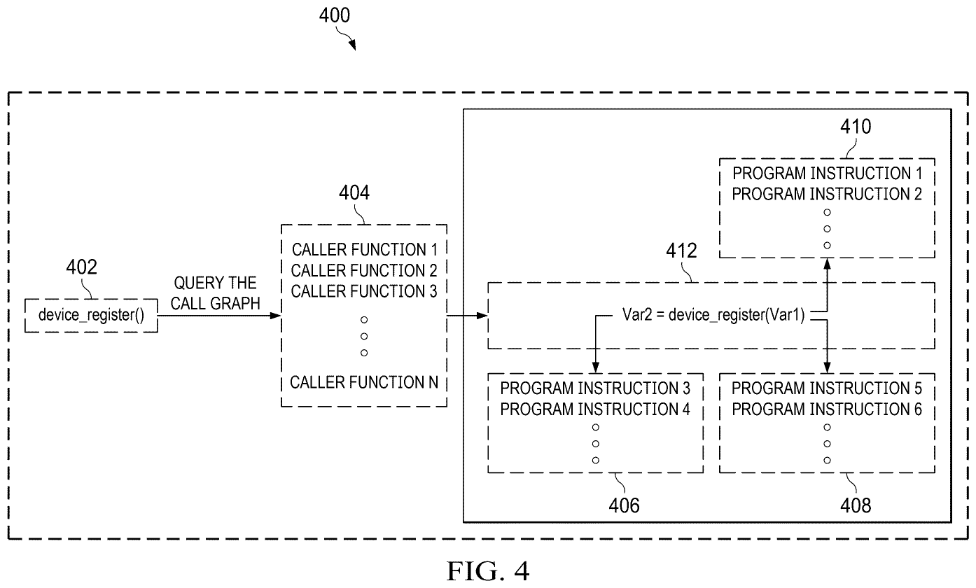

With reference now to FIG. 4, a graph to illustrate associations between variables and caller functions for identifying context for target code segment that are potentially affected by existing bugs is shown in accordance with an illustrative embodiment. In this illustrative example, graph 400 illustrates an exemplary process for identifying target code segment 254 in FIG. 2.

Graph 400 includes target code segment 402 that is potentially responsible for a bug addressed by a patch. In this illustrative example, target code segment 402 is a portion of a program and can be an example of target code segment 254 in FIG. 2. In FIG. 4, a number of caller functions 404 can be identified by querying call graph for target code segment 402. The call graph is a visual representation of calling relationships between different functions or methods within program instructions. In this illustrative example, the call graph can be a source that provides dependencies between different functions or methods in program instructions.

In this illustrative example, “caller” 1 in the number of caller functions 404 includes function 412 which is associated with target code segment 402. Function 412 computes “variable 2” by inputting “variable 1” into target code segment 402. In this illustrative example, a control flow analysis can be performed to identify other program instructions that are related to “variable 1” and “variable 2”. Control flow analysis is a technique used to determine the order in which individual instructions or function calls are executed. In FIG. 4, program instructions 406 are identified to be related to “variable 2” in function 412. In addition, program instructions 408 and program instructions 410 are identified to be related to “variable 1” in function 412.

In this illustrative example, caller functions 404, program instructions 406, program instructions 408, program instructions 410, and variables in function 412 forms context for target code segment 402 and can be part of prompt used for identifying bugs.

The illustration in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, context formed for target code segment 402 can include other information associated with target code segment 402 in addition to caller functions 404, program instructions 406, program instructions 408, program instructions 410, and variables in function 412.

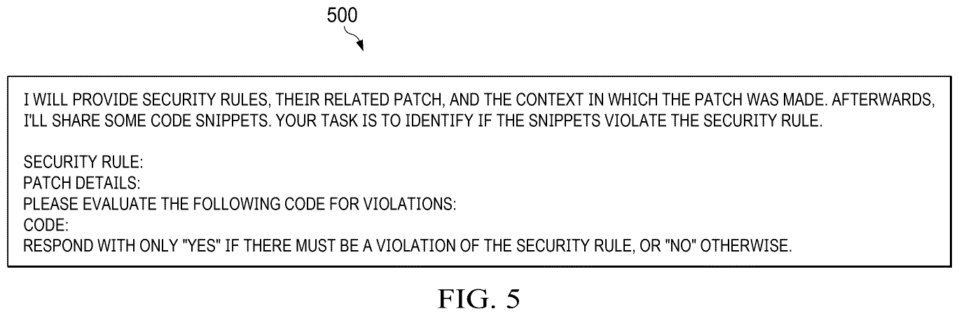

With reference now to FIG. 5, a prompt for a large language model to detect bugs is shown in accordance with an illustrative embodiment. In this illustrative example, prompt 500 can be an example of prompt 250 for large language model 212 in FIG. 2.

In FIG. 5, prompt 500 is an input for a large language model such that the large language model can perform tasks based on the content specified in prompt 500. In this illustrative example, prompt 500 specifies that the task to be performed is to identify if program instructions provided by prompt 500 violate security rule specified in prompt 500. In other words, prompt 500 is constructed for a large language model to identify bugs based on security rule identified based on existing bugs. In this illustrative example, the security rule in prompt 500 can be an example of security rule 228 in FIG. 2. The security rule specified in prompt 500 can be identified using the method depicted in FIG. 3. In addition, the “Code” provided by prompt 500 can include program instructions and context for the program instructions, which are identified using the method depicted in FIG. 4.

As depicted, prompt 500 also provides patch details for evaluating programs instruction to determine whether the program instructions are affected by bugs that violate the security rule specified in prompt 500. In this illustrative example, the patch details in prompt 500 can be an example of information associated with patch 222 in FIG. 2. In a similar fashion, the patch details specified in prompt 500 can also be identified using the method depicted in FIG. 3. By such a method, the large language model that takes prompt 500 as input can effectively identify program instructions that are also affected by existing bugs.

The illustration of prompt 500 in FIG. 5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, prompt 500 can be phrased in any suitable way and can include information associated with potential bugs other than the information shown in FIG. 5.

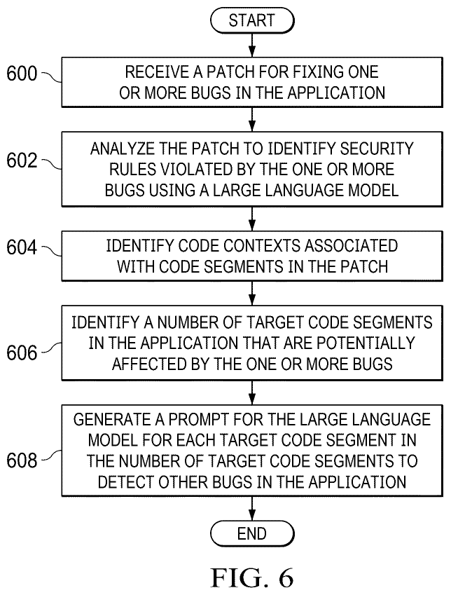

With reference now to FIG. 6, a flowchart illustrating a process for detecting bugs in an application is shown in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in security manager 220 in computer system 204 in FIG. 2.

The process begins by receiving a patch for fixing one or more bugs in the application (step 600). The process analyzes the patch to identify security rules violated by the one or more bugs using a large language model (step 602). In step 602, few-shots prompt can be used to guide the large language model for generating the security rules by providing the large language model with some examples. In this illustrative example, an exemplary few-shots prompt that can be used to guide the large language model for generating the security rules can be as follows:

<|system|>
You are a security expert. You are a helpful assistant. You carefully
follow instructions.
Your response should only include the answer. Do not provide any
further explanation.
<|user|>
Your task is to condense the comments from a Git commit into a single,
coherent sentence, ensuring it captures how a specific function is
intended to be utilized.
Here are some examples of summarization, complete the last one:
[Input 1]:
zorro: Fix device_register( ) error handling
If device_register( ) fails then call put_device( ).
See comment to device_register.
[Output 1]:
If device_register( ) fails, it is essential to call put_device( ) to
properly manage resources and prevent leaks.
[Input 2]:
net: ethernet: ezchip: fix error handling
the driver should check that platform_get_irq( ) return value
is _negative_, not that it's equal to zero, because −ENXIO (return
value from request_irq( ) if irq was not found) will
pass this check and it leads to passing negative irq to request_irq( )
Also, the print function dev_err( ) is redundant because
platform_get_irq( ) already prints an error.
[Output 2]:
After calling platform_get_irq( ), it is essential to check if its return
value is negative.
[Input]:
{Content of the Patch}
[Output]:
<|assistant|>

In another example, the process can also use zero-shots prompt to guide the large language model for generating the security rules by providing the large language model with task description and content for the patch. In this illustrative example, an exemplary zero-shots prompt that can be used to guide the large language model for generating the security rules can be as follows:

<|system|>
You are a security expert. You are a helpful assistant. You carefully
follow instructions.
Your response should only include the answer. Do not provide any
further explanation.
<|user|>
Your task is to summarize multiple similar coding rules into a single,
coherent sentence.
Here are the coding rules you need to summarize.
Input:
{Content of the Patch}
Output:
<|assistant|>

The process identifies code contexts associated with code segments in the patch, wherein the code segments are responsible for the one or more bugs in the application (step 604). The process identifies a number of target code segments in the application that are potentially affected by the one or more bugs (step 606).

The process generates a prompt for the large language model for each target code segment in the number of target code segments to detect other bugs in the application (step 608). In step 608, the prompt is generated based on security rules, the code contexts, and the number of target code segments in the application. The process terminates thereafter.

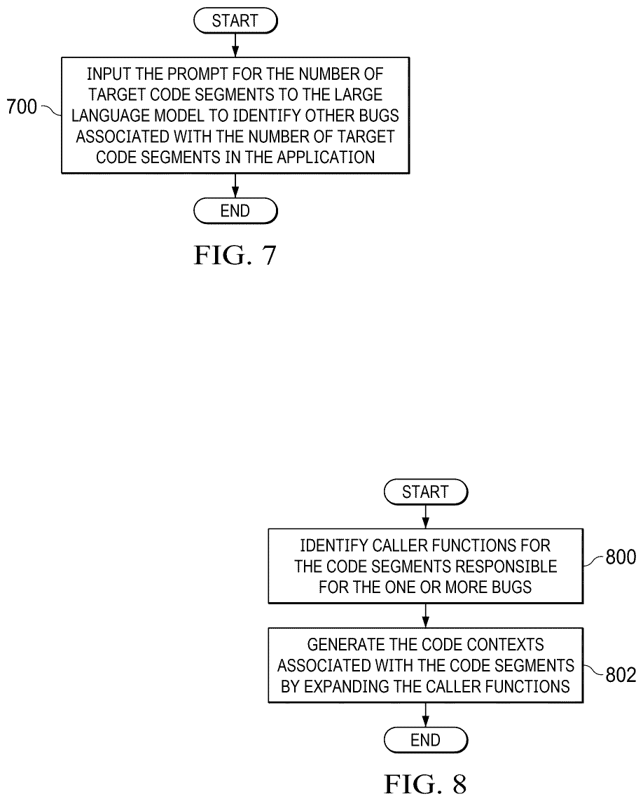

Turning next to FIG. 7, a flowchart of a process for inputting prompt to a large language model is depicted in accordance with an illustrative embodiment. The process in this figure is an example of an additional step that can be performed with the steps in FIG. 6.

The process begins by inputting the prompt for the number of target code segments to the large language model to identify other bugs associated with the number of target code segments in the application (step 700). The process terminates thereafter.

Turning next to FIG. 8, a flowchart of a process for identifying code contexts is depicted in accordance with an illustrative embodiment. The process in this flowchart is an example of an implementation for step 604 in FIG. 6.

The process begins by identifying caller functions for the code segments responsible for the one or more bugs (step 800). The process generates the code contexts associated with the code segments by expanding the caller functions (step 802). The process terminates thereafter.

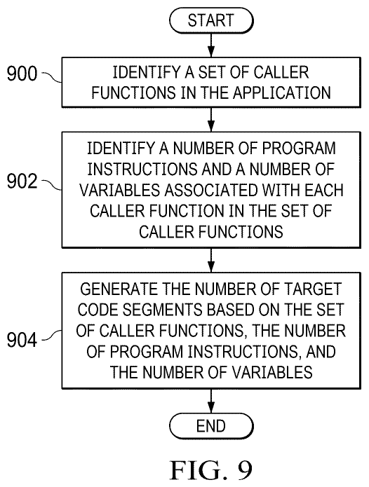

Turning next to FIG. 9, a flowchart of a process for identifying target code segments in the application is depicted in accordance with an illustrative embodiment. The process in this flowchart is an example of an implementation for step 606 in FIG. 6.

The process begins by identifying a set of caller functions in the application (step 900). In step 900, the set of caller functions are caller functions for the code segments responsible for the one or more bugs. The process identifies a number of program instructions and a number of variables associated with each caller function in the set of caller functions (step 902). The process generates the number of target code segments based on the set of caller functions, the number of program instructions, and the number of variables (step 904). The process terminates thereafter.

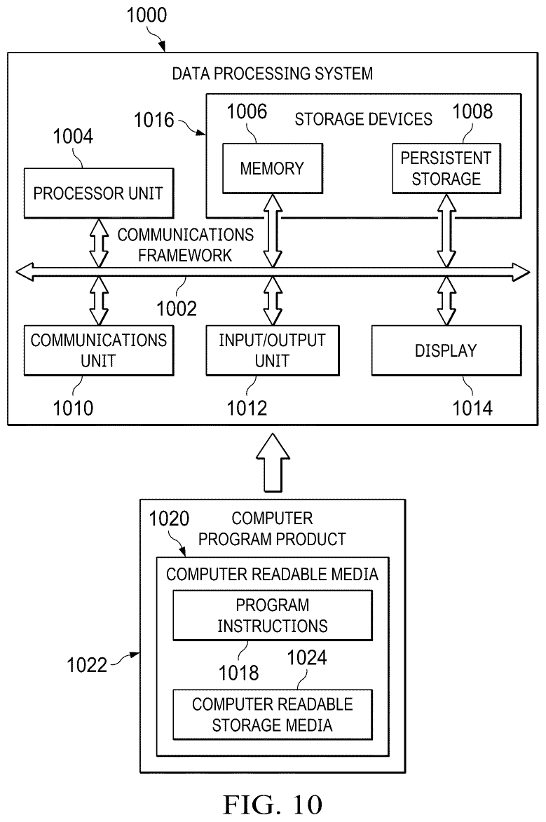

Turning now to FIG. 10, a block diagram of a data processing system is depicted in accordance with an illustrative embodiment. Data processing system 1000 can be used to implement computers and computing devices in computing environment 100 in FIG. 1. Data processing system 1000 can also be used to implement computer system 204 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer-readable program instructions that can be read and executed by a processor in processor unit 1004. The program instructions in the different embodiments can be embodied on different physical or computer-readable storage media, such as memory 1006 or persistent storage 1008.

Program instructions 1018 are located in a functional form on computer readable media 1020 that is selectively removable and can be loaded onto or transferred to data processing system 1000 for execution by processor unit 1004. Program instructions 1018 and computer readable media 1020 form computer program product 1022 in these illustrative examples. In the illustrative example, computer readable media 1020 is computer readable storage media 1024.

Computer readable storage media 1024 is a physical or tangible storage device used to store program instructions 1018 rather than a medium that propagates or transmits program instructions 1018. Computer readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1018 can be transferred to data processing system 1000 using a computer readable signal media. The computer-readable signal media are signals and can be, for example, a propagated data signal containing program instructions 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1020” can be singular or plural. For example, program instructions 1018 can be located in computer readable media 1020 in the form of a single storage device or system. In another example, program instructions 1018 can be located in computer readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer readable media 1020 in a server computer while another portion of program instructions 1018 can be located in computer readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for detecting bugs in an application, the computer implemented method comprising:
receiving, by a processor set, a patch for fixing one or more bugs in the application;
analyzing, by the processor set, the patch to identify security rules violated by the one or more bugs using a large language model;
identifying, by the processor set, code contexts associated with code segments in the patch, wherein the code segments are responsible for the one or more bugs in the application;
identifying, by the processor set, a number of target code segments in the application that are potentially affected by the one or more bugs; and
generating, by the processor set, a prompt for the large language model for each target code segment in the number of target code segments to detect other bugs in the application, wherein the prompt is generated based on security rules, the code contexts, and the number of target code segments in the application.

2. The computer implemented method of claim 1, further comprising:
inputting, by the processor set, the prompt for the number of target code segments to the large language model to identify other bugs associated with the number of target code segments in the application.

3. The computer implemented method of claim 1, wherein identifying, by the processor set, code contexts associated with code segments in the patch comprises:
identifying, by the processor set, caller functions for the code segments responsible for the one or more bugs; and
generating, by the processor set, the code contexts associated with the code segments by expanding the caller functions.

4. The computer implemented method of claim 1, wherein identifying, by the processor set, the number of target code segments in the application that are potentially affected by the one or more bugs comprises:
identifying, by the processor set, a set of caller functions in the application, wherein the set of caller functions are caller functions for the code segments responsible for the one or more bugs;
identifying, by the processor set, a number of program instructions and a number of variables associated with each caller function in the set of caller functions; and
generating, by the processor set, the number of target code segments based on the set of caller functions, the number of program instructions, and the number of variables.

5. The computer implemented method of claim 4, wherein the set of caller functions in the application is identified using a call graph for the code segments responsible for the one or more bugs.

6. The computer implemented method of claim 4, wherein the number of program instructions and the number of variables associated with each caller function in the set of caller functions are identified based on control flow analysis.

7. The computer implemented method of claim 1, wherein the security rules violated by the one or more bugs are identified based on description and changes in program instructions for application from content of the patch.

8. A computer system comprising:
a processor set;
a set of one or more computer-readable storage media; and
program instructions, collectively stored in the set of one or more storage media, for causing the processor set to perform the following computer operations:
receive a patch for fixing one or more bugs in an application;
analyze the patch to identify security rules violated by the one or more bugs using a large language model;
identify code contexts associated with code segments in the patch, wherein the code segments are responsible for the one or more bugs in the application;
identifying, by the processor set, a number of target code segments in the application that are potentially affected by the one or more bugs; and
generate a prompt for the large language model for each target code segment in the number of target code segments to detect other bugs in the application, wherein the prompt is generated based on security rules, the code contexts, and the number of target code segments in the application.

9. The computer system of claim 8, wherein the program instructions, collectively stored in the set of one or more storage media, further cause the processor set to perform the following computer operations:
input the prompt for the number of target code segments to the large language model to identify other bugs associated with the number of target code segments in the application.

10. The computer system of claim 8, wherein as part of wherein identifying code contexts associated with code segments in the patch, the program instructions, collectively stored in the set of one or more storage media, cause the processor set to perform the following computer operations:
identify caller functions for the code segments responsible for the one or more bugs; and
generate the code contexts associated with the code segments by expanding the caller functions.

11. The computer system of claim 8, wherein as part of identifying the number of target code segments in the application that are potentially affected by the one or more bugs, the program instructions, collectively stored in the set of one or more storage media, cause the processor set to perform the following computer operations:
identify a set of caller functions in the application, wherein the set of caller functions are caller functions for the code segments responsible for the one or more bugs;
identify a number of program instructions and a number of variables associated with each caller function in the set of caller functions; and
generate the number of target code segments based on the set of caller functions, the number of program instructions, and the number of variables.

12. The computer system of claim 11, wherein the set of caller functions in the application is identified using a call graph for the code segments responsible for the one or more bugs.

13. The computer system of claim 11, wherein the number of program instructions and the number of variables associated with each caller function in the set of caller functions are identified based on control flow analysis.

14. The computer system of claim 8, wherein the security rules violated by the one or more bugs are identified based on description and changes in program instructions for application from content of the patch.

15. A computer program product for detecting bugs in an application, the computer program product comprising:
a set of one or more computer-readable storage media;
program instructions, collectively stored in the set of one or more storage media, cause a processor set to perform the following computer operations:
receive a patch for fixing one or more bugs in an application;
analyze the patch to identify security rules violated by the one or more bugs using a large language model;
identify code contexts associated with code segments in the patch, wherein the code segments are responsible for the one or more bugs in the application;
identify, by the processor set, a number of target code segments in the application that are potentially affected by the one or more bugs; and
generate a prompt for the large language model for each target code segment in the number of target code segments to detect other bugs in the application, wherein the prompt is generated based on security rules, the code contexts, and the number of target code segments in the application.

16. The computer program product of claim 15, wherein the program instructions, collectively stored in the set of one or more storage media, further cause the processor set to perform the following computer operations:
input the prompt for the number of target code segments to the large language model to identify other bugs associated with the number of target code segments in the application.

17. The computer program product of claim 15, wherein as part of identifying code contexts associated with code segments in the patch, the operation performed by the processor set comprises:
identify caller functions for the code segments responsible for the one or more bugs; and
generate the code contexts associated with the code segments by expanding the caller functions.

18. The computer program product of claim 15, wherein as part of identifying the number of target code segments in the application that are potentially affected by the one or more bugs, the operation performed by the processor set comprises:
identify a set of caller functions in the application, wherein the set of caller functions are caller functions for the code segments responsible for the one or more bugs;
identify a number of program instructions and a number of variables associated with each caller function in the set of caller functions; and
generate the number of target code segments based on the set of caller functions, the number of program instructions, and the number of variables.

19. The computer program product of claim 18, wherein the set of caller functions in the application is identified using a call graph for the code segments responsible for the one or more bugs.

20. The computer program product of claim 18, wherein the number of program instructions and the number of variables associated with each caller function in the set of caller functions are identified based on control flow analysis.
